(19) United States
(12) Patent Application Publication
(10) Pub. No.: US 2010/0097130 A1
(43) Pub. Date: Apr. 22, 2010

(54) DEVICE HAVING CIRCUIT CAPABLE OF INTERMITTENT OPERATION

(75) Inventors: Kenji Kanamaru, Kanagawa-ken (JP); Mitsuru Sugawara, Kanagawa-ken (JP); Akihiro Kawano, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/575,763

(22) Filed: Oct. 8, 2009

(30) Foreign Application Priority Data
Oct. 21, 2008 (JP) 2008-270933

(51) Int. Cl. G05F 1/10

(52) U.S. Cl. 327/544

(57) ABSTRACT

A circuit unit is provided. The circuit unit has an intermittent operation circuit. The intermittent operation circuit is set in an operation state and in a stand-by state periodically. An operation mode control unit generates a test mode control signal to designate either an operation test mode or an intermittent operation test mode of the intermittent operation circuit. The operation test mode corresponds to one of a continuous operation or a predetermined time period operation of the intermittent operation circuit. An operation timing generation unit receives the test mode control signal. The operation timing generation unit produces an operation control signal based on the test mode control signal. The operation control signal is outputted to the intermittent operation circuit to operate or wait the intermittent operation circuit.

### CROSS REFERENCE TO RELATED APPLICATION

This application is based upon and claims the benefit of priority from the prior Japanese Patent Application No. 2008-270933, filed on Oct. 21, 2008, the entire contents of which are incorporated herein by reference.

### FIELD OF THE INVENTION

The invention relates to a device having a circuit capable of intermittent operation in a stand-by mode.

### DESCRIPTION OF THE BACKGROUND

With recent progress in miniaturization, integration, and high speed operation of a semiconductor element, a highly integrated semiconductor device such as a system LSI or a SoC (System on a Chip) consumes more power because of leaking current flowing during stand-by. A mobile equipment is required to show low power consumption. Therefore, the mobile equipment needs to reduce power consumption during stand-by.

In order to reduce power consumption during stand-by, an intermittent operation technique is used widely in various fields. The intermittent operation technique interrupts and supplies power to a circuit which is not required to operate during stand-by, intermittently. Japanese Patent Application Publication No. 2003-188798 discloses a semiconductor device employing such an intermittent operation technique.

It takes a long time for a test apparatus to carry out a whole test process of the semiconductor device disclosed in the patent publication. It is because the operation test can not be carried out by the test apparatus during stand-by so that a waiting time period arises in the test apparatus to perform the operation test.

Further, the stand-by operation test is required to be performed at the same time of intermittent operation depending on the type of the semiconductor device. Therefore, the semiconductor device may cause restrictions in test facilities and test control software.

### SUMMARY OF THE INVENTION

An aspect of the invention provides a device having a circuit capable of intermittent operation including a circuit unit, having an intermittent operation circuit being set in an operation state and in a stand-by state periodically, an operation mode control unit, generating a test mode control signal to designate either an intermittent operation test mode of the intermittent operation circuit or an operation test mode corresponding to one of a continuous operation or a predetermined time period operation of the intermittent operation circuit, and an operation timing generation unit, receiving the test mode control signal, and producing an operation control signal to provide to and to operate or wait the intermittent operation circuit based on the test mode control signal.

Another aspect of the invention provides a device having a circuit capable of intermittent operation including a signal processing circuit capable of selectively performing a normal operation and an intermittent operation performing alternately a normal state and a stand-by state, an operation mode control unit generating a test mode control signal, the test mode control signal designating a normal operation test mode and an intermittent operation test mode of the signal processing circuit, and an operation timing generation unit, receiving the test mode control signal, and outputting an operation control signal making the signal processing circuit perform the normal operation and the intermittent operation to the signal processing circuit based on the test mode control signal.

### BRIEF DESCRIPTION OF THE DRAWINGS

FIG. 1 is a block diagram illustrating a sensor LSI according to a first embodiment of the invention.

FIG. 2 is a timing chart illustrating an operation of the sensor LSI according to the first embodiment.

FIG. 3 is a timing chart illustrating a test process of the sensor LSI according to the first embodiment.

FIG. 4 is a block diagram illustrating a transmission/reception module according to a second embodiment of the invention.

FIG. 5 is a timing chart illustrating a test process of the transmission/reception module according to the second embodiment of the invention.

### DETAILED DESCRIPTION OF THE INVENTION

Hereinafter, embodiments of the invention will be described with reference to the drawings.

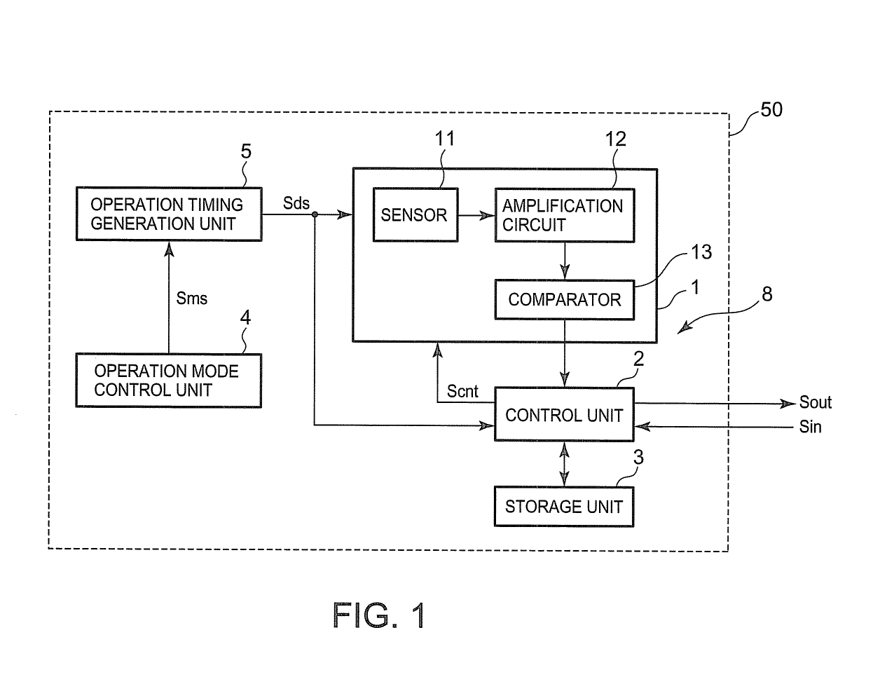

A sensor LSI according to a first embodiment of the invention will be described with reference to FIG. 1. The sensor LSI is a semiconductor integrated circuit provided with a sensor. FIG. 1 is a block diagram illustrating the sensor LSI according to the first embodiment.

As shown in FIG. 1, a sensor LSI 50 is provided with a sensor unit 1, a control unit 2, a storage unit 3, an operation mode control unit 4, and an operation timing generation unit 5. The sensor LSI 50 senses magnetic field and outputs a signal corresponding to the strength of the magnetic field.

The sensor LSI 50 interrupts power supply to a circuit not required to operate during stand-by. During the stand-by, the sensor LSI 50 does not sense magnetic field. The sensor unit 1, the control unit 2, and the storage unit 3 constitute a signal processing circuit 8. Hereinafter, the “signal processing circuit” is referred to as a circuit unit to perform processing including amplification, A/D conversion, arithmetic operation, transfer or storing of a signal.

The sensor unit 1 enters a stand-by state when a power source (not shown) is interrupted, or when the operation of the sensor unit 1 is stopped by an operation control signal Sds, which will be described in detail later. The sensor unit 1 performs a normal operation and an intermittent operation selectively. An operation state and a stand-by state of the sensor unit 1 are set periodically in the intermittent operation. The sensor LSI 50 senses magnetic field in the embodiment. Instead, a sensor LSI may be one which senses temperature, light, displacement (position), pressure, electric field or gravity (acceleration). The sensor LSI may be one which senses several of these quantities.

The operation mode control unit 4 is used when the sensor LSI 50 is tested. The operation mode control unit 4 generates a mode control signal Sms to designate either one of an intermittent operation test mode and a normal operation test mode. The operation mode control unit 4 outputs a generated mode control signal Sms to the operation timing generation unit 5.

The operation timing generation unit 5 is used when the sensor LSI 50 is tested. The operation timing generation unit 5 generates an operation control signal Sds based on the mode control signal Sms. The operation control signal Sds causes the sensor unit 1 and the control unit 2 to operate or to enter a stand-by state.

The operation control signal Sds may be outputted also to the storage unit 3 in addition to outputting to the sensor unit 1 and the control unit 2. In the embodiment, the storage unit 3 is caused to operate or to enter a stand-by state when the sensor LSI 50 is tested.

The sensor unit 1 is provided with a sensor 11, an amplification circuit 12, and a comparator 13.

Upon sensing magnetic field, the sensor 11 generates an output voltage proportional to the strength of the magnetic field, in response to the magnetic field. The sensor 11 outputs the output voltage to the amplification circuit 12. A hall element or an MR element may be employed as the sensor 11.

The amplification circuit 12 receives the output voltage outputted from the sensor 11, and amplifies the output voltage.

The comparator 13 compares an output voltage of the amplification circuit 12 with a predetermined reference voltage. The comparator 13 outputs a result of the comparison to the control unit 2. The comparator 13 determines whether the output voltage is at a “High” level or at a “Low” level by comparison with the predetermined reference voltage. A plurality of predetermined reference voltages may be prepared to sort the output voltage of the amplification circuit 12 into a plurality of ranks. The output voltage of the amplification circuit 12 corresponds to the strength of the magnetic field.

The control unit 2 outputs a control signal Scnt for controlling the operation of the sensor unit 1 to the sensor unit 1. The control unit 2 receives information outputted from the comparator 13. The control unit 2 outputs the information received from the comparator 13, as an output signal Sout, to the outside. The control unit 2 receives an input signal Sin from the outside. The input signal Sin includes information for controlling the operation of the sensor unit 1.

The storage unit 3 receives information corresponding to the strength of the magnetic field sensed by the sensor 1, through the control unit 2. The storage unit 3 stores the information. The stored information may be outputted to the outside through the control unit 2. The storage unit 3 stores the input signal Sin which is received by the control unit 2.

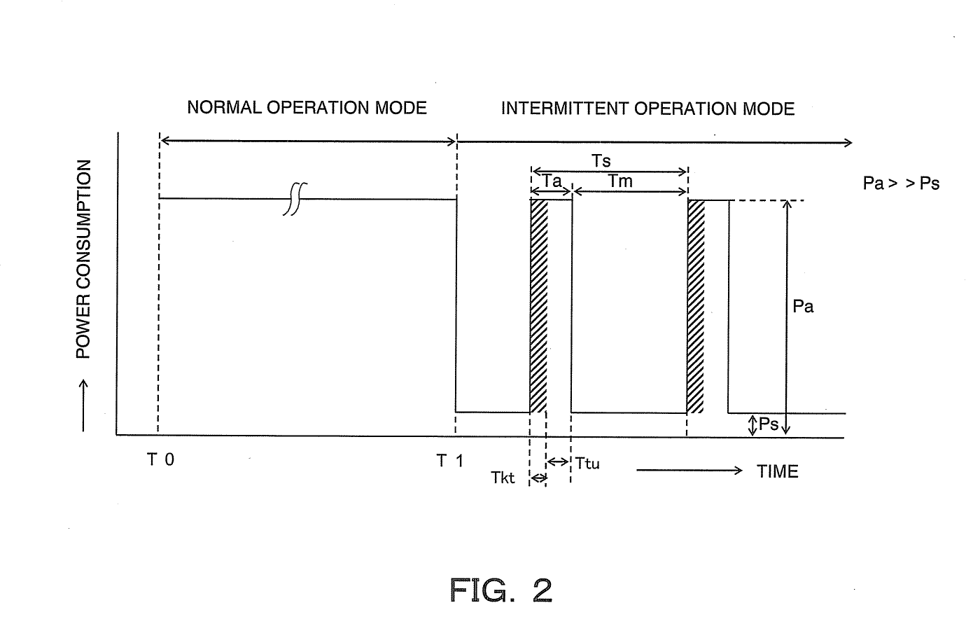

FIG. 2 is a timing chart illustrating the operation of the sensor LSI 50. As shown in FIG. 2, when electric power is supplied from a power source (not shown) to the sensor LSI 50 at a time point T0, the sensor LSI 50 starts a continuous operation and enters a normal operation mode. Specifically, the sensor unit 1 senses magnetic field, and then the sensed information of the magnetic field is transmitted from the sensor unit 1 to the control unit 2.

At a time point T1 which is a predetermined time after the start of the sensing operation, the sensor unit 1 enters an intermittent operation mode based on the control signal Scnt from the control unit 2 shown in FIG. 1. In the intermittent operation mode, an operation mode and a stand-by mode are repeated alternately and periodically. A time period Ta during which the operation mode is active is a sum of a time period Tkt taken for starting up the circuit of the sensor unit 1 and a time period Tsu taken for communicating the information sensed by the sensor unit 1.

After the sensed information is transmitted, the sensor unit 1 is set to the stand-by mode. In the stand-by mode, the sensor unit 1 stops the operation. The time period set for the stand-by mode is a stand-by time period Tm. A cycle time Ts is a sum of the operation time period Ta in the intermittent operation mode and the stand-by time period Tm in the intermittent operation mode. The stand-by time period Tm and the cycle time Ts are set by the control signal Scnt outputted from the control unit 2 shown in FIG. 1.

The following inequality shows the relationship between an electric power Pa consumed during the operation mode and an electric power Ps consumed during the stand-by mode, which are set in the intermittent operation mode respectively.

Pa>>Ps (1)

The power consumption of the sensor LSI 50, which performs the intermittent operation, is reduced, when the relationship between the operation time period Ta and the stand-by time period Tm is set in accordance with the following inequality.

Tm>>Ta (2)

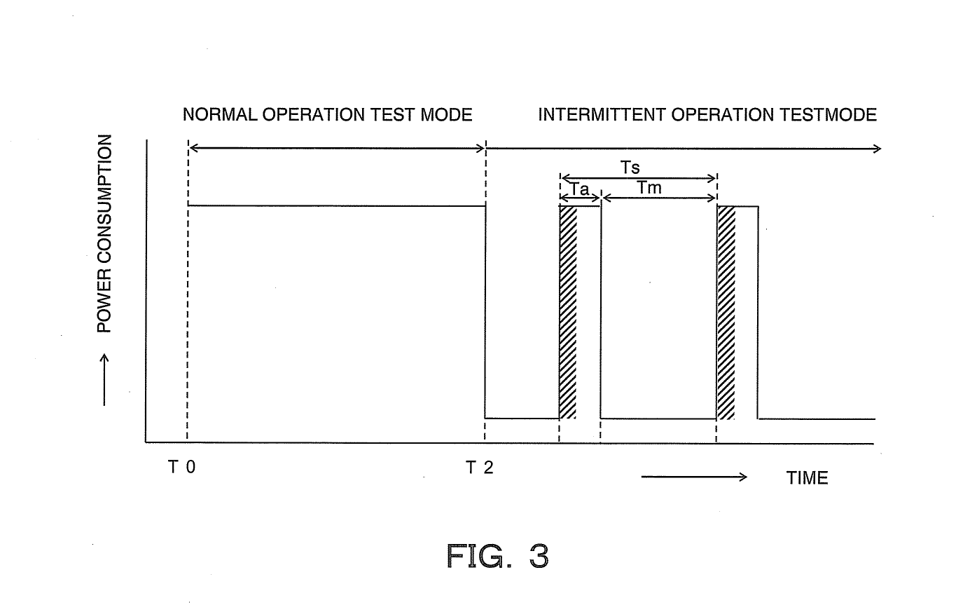

A test process for the sensor LSI 50 will be described with reference to FIG. 3.

As shown in FIG. 3, in testing the sensor LSI 50, electric power is supplied to the sensor unit 1, the control unit 2, the storage unit 3, the operation mode control unit 4, and the operation timing generation unit 5 shown in FIG. 1 respectively, after the start of the test.

A mode control signal Sms is outputted from the operation mode control unit 4 to the operation timing generation unit 5. The mode control signal Sms causes the operation timing generation unit 5 to output a operation control signal Sds to the sensor unit 1. The operation control signal Sds causes the sensor unit 1 to operate continuously. At the time point T0 in FIG. 3, the sensor unit 1 starts the continuous operation.

At this time, a control signal Scnt is not outputted from the control unit 2 to cause the sensor unit 1 to operate intermittently, since the operation control signal Sds is inputted to the control unit 2. A normal operation test mode is active from the start of the test to the time point T2 before the mode switching. In the normal operation test mode, operation tests are continuously executed for the sensor unit 1, the control unit 2, and the storage unit 3. Whether the sensor LSI 50 is satisfactory or not is determined by using a test apparatus (not shown).

After the operation tests are completed in the normal operation test mode, the operation control signal Sds from the operation timing generation unit 5 causes the control unit 2 to output a control signal Scnt to the sensor unit 1. An intermittent operation of the sensor unit 1 is started according to the control signal Scnt so that an intermittent operation test mode is performed. Then, the test apparatus determines whether the sensor LSI 50 is satisfactory or not. A cycle time Ts and an operation time period Ta given in the intermittent operation test mode as well as a stand-by time period Tm given in the intermittent operation test mode are similar to those given in the intermittent operation mode of the sensor LSI 50.

As described above, according to the embodiment, since the end time point T2 of the normal operation test mode can be earlier than the end time point T1 of the normal operation mode, the waiting time period of the test apparatus can be decreased and can complete the test promptly. Therefore, the time required for the test process can be shortened.

The operation tests of the sensor LSI 50 do not require consideration of timing of intermittent operation, depending on the type of the sensor LSI 50 as a test target. Accordingly, the sensor LSI 50 does not cause restrictions in test facilities and test control software. The sensor LSI 50 operates to test itself autonomously so that the sensor LSI 50 does not need a special tester. Further, a test terminal, which is provided to control the test modes of the sensor LSI 50 from the outside, is not necessary in the sensor LSI 50.

The embodiment employs a sensor LSI capable of intermittent operation, as a semiconductor device. In place of the sensor LSI, a PLL synthesizer LSI, a radio reception LSI, a mobile baseband LSI, a position sensing LSI, a motor control LSI or a converter control LSI, which is capable of intermittent operation, may be employed. An analog baseband LSI, in which a filter circuit performs intermittent operation, or a microcomputer or a processor, in which a CPU performs intermittent operation, may be employed.

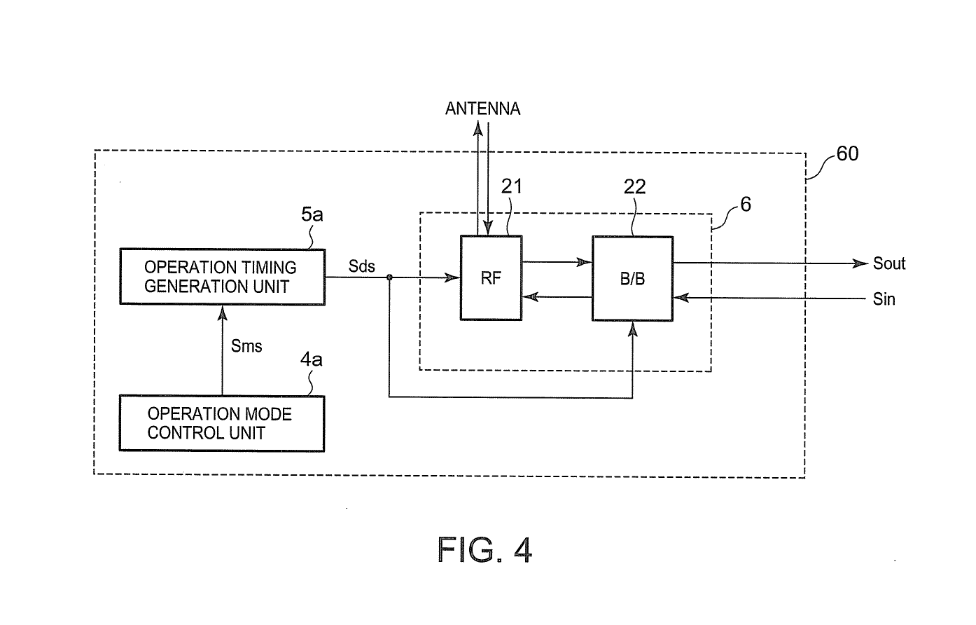

A transmission/reception module according to a second embodiment of the invention will be described with reference to FIG. 4.

As shown in FIG. 4, a transmission/reception module 60 is provided with a transmission/reception unit 6 as a circuit unit, an operation mode control unit 4a and an operation timing generation unit 5a. The transmission/reception unit 6 may be replaced by a transmission unit or a reception unit. The transmission/reception module 60 is used for mobile communication, for example. During a stand-by time period, the transmission/reception module 60 interrupts power supply to a circuit not required to operate. The transmission/reception module 60 does not receive any high-frequency signal being inputted through an antenna (not shown) during the stand-by time period. The transmission/reception module 60 performs an intermittent stand-by operation. The transmission/reception unit 6, the operation mode control unit 4a, and the operation timing generation unit 5a are formed on the same module board (not shown).

The transmission/reception unit 6 includes an RF (radio frequency) signal unit 21 and a baseband signal unit 22. The transmission/reception unit 6 constitutes a signal processing circuit. The RF unit 21 and the baseband signal unit 22 have a function to perform a normal operation and the intermittent stand-by operation selectively. In the intermittent stand-by operation, a PLL circuit provided in the RF unit 21 performs intermittent operation, and a processor provided in the baseband signal unit 22 performs intermittent operations. In the intermittent operation, an operation state and a stand-by state are set periodically for each of the PLL circuit and the processor.

The operation mode control unit 4a is used when the transmission/reception module 60 is tested. The operation mode control unit 4a generates a mode control signal Sms to designate either one of an intermittent operation test mode and a normal operation test mode. The generated mode control signal Sms is received by the operation timing generation unit 5a.

The operation timing generation unit 5a is used when the transmission/reception module 60 is tested. The operation timing generation unit 5a generates an operation control signal Sds in accordance with the mode control signal Sms. The operation control signal Sds causes the transmission/reception unit 6 to operate or to enter a stand-by state. The generated operation control signal Sds is received by the RF unit 21 and by the baseband signal unit 22, as a control signal.

The RF unit 21 of the transmission/reception unit 6 may be composed of a plurality of semiconductor chips. The RF unit 21 receives a weak high-frequency signal being inputted through the antenna. The inputted high-frequency signal is amplified by the RF unit 21. The amplified signal is frequency-converted by the RF unit 21. The frequency-converted signal is received by the baseband signal unit 22. On the other hand, the RF unit 21 has a function to frequency-convert a signal outputted from the baseband signal unit 22 and a function to output the high-powered high-frequency signal through the antenna.

The baseband signal unit 22 processes the signal frequency-converted by the RF unit 21, and outputs the processed signal to the outside as an output signal Sout. The baseband signal unit 22 receives an input signal Sin of a baseband being inputted from the outside. The baseband signal unit 22 processes the input signal Sin and outputs the processed signal to the RF unit 21.

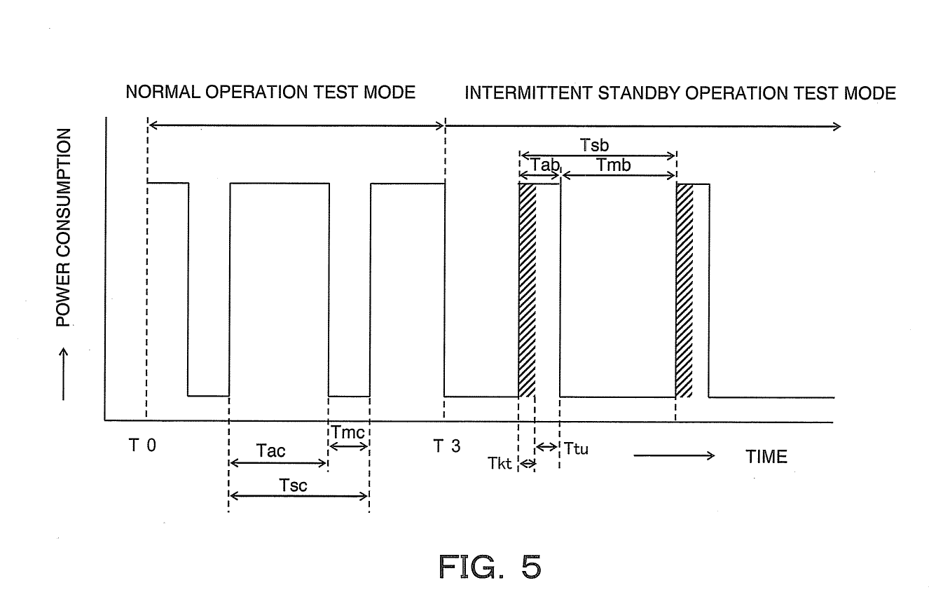

A test operation of the transmission/reception module 60 will be described with reference to FIG. 5.

As show in FIG. 5, in a test process of the transmission/reception module 60, electric power is intermittently supplied from a power source to the transmission/reception unit 6, the operation mode control unit 4a, and the operation timing generation unit 5a, with start of the normal operation test mode at a time point T0. In the normal operation test mode, a operation control signal Sds is outputted from the operation timing generation unit 5a in accordance with a mode control signal Sms being outputted from the operation mode control unit 4a. The operation control signal Sds sets an operation time period Tac, a stand-by time period Tmc and a cycle time Tsc of the transmission/reception module 60 in accordance with the following inequalities.

Tac>Tmc (3)

Tsc=Tac+Tmc (4)

The normal operation test of the transmission/reception module 60 is executed during the operation time period Tac. In the normal operation test, whether the transmission/reception module 60 is satisfactory or not is determined by using a test apparatus. The normal operation test is executed at least for one cycle.

At a time point T3 after the test performed in the normal operation test mode is completed, the operation control signal Sds is outputted from the operation timing generation unit 5a in accordance with the mode control signal Sms from the operation mode control unit 4a. The outputted operation control signal Sds makes the transmission/reception module 60 enter an intermittent stand-by operation test mode. An operation time period Tab, a stand-by time period Tmb and a cycle time Tsb are set in accordance with the following inequalities.

Tab<Tmb (5)

Tsb=Tab+Tmb (6)

The stand-by time period Tmb of the intermittent stand-by operation test mode may be set voluntarily so far as the stand-by time period Tmb is smaller than the stand-by time period of the intermittent stand-by operation mode of the transmission/reception module 60. The cycle time Tsb is set to be shorter than the cycle time of the intermittent stand-by operation mode.

The intermittent stand-by operation test of the transmission/reception module 60 is executed during the operation time period Tab. Whether the transmission/reception module 60 is satisfactory or not is determined by using the test apparatus. The intermittent stand-by operation test is executed at least for one cycle.

In the embodiment, the intermittent stand-by operation test mode is performed after the normal operation test mode is performed by providing the operation mode control unit and the operation timing generation unit in the transmission/reception module 60. As a result, testing time of the test process for the transmission/reception module 60 can be shortened, as compared with that of a test process where an operation mode control unit and an operation timing generation unit are not provided.

In the test process shown in FIG. 5, a predetermined time period is provided between the mode shift and the start of the intermittent stand-by operation test. Alternatively, the intermittent stand-by operation test may be started immediately after the mode shift without providing the predetermined time period.

In the embodiment, the stand-by time period Tmb of the intermittent stand-by operation test mode is smaller than the stand-by time period of the intermittent stand-by operation mode of the transmission/reception module 60. Accordingly, the time period required for a test process can be shortened.

Further, the operation tests do not need to be executed in consideration of timing of intermittent stand-by operation, depending on the type of the transmission/reception module 60. Accordingly, the transmission/reception module 60 does not cause restrictions in test facilities and test control software.

The transmission/reception module 60 operates autonomously so that a special tester is not necessary. A test terminal is not necessary for controlling a test mode in the transmission/reception module 60.

The embodiment is applied to the transmission/reception module 60 to perform an intermittent stand-by operation. The embodiment may also be applied to a sensor module, a position sensing module, a motor control module or a converter control module which performs intermittent operation, or an analog baseband module which has a filter circuit to perform an intermittent operation.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A device having a circuit capable of intermittent operation, comprising:
a circuit unit, having an intermittent operation circuit being set in an operation state and in a stand-by state periodically;
an operation mode control unit, generating a test mode control signal to designate either an intermittent operation test mode of the intermittent operation circuit or an operation test mode corresponding to one of a continuous operation or a predetermined time period operation of the intermittent operation circuit; and
an operation timing generation unit, receiving the test mode control signal, and producing an operation control signal to provide to and to operate or wait the intermittent operation circuit based on the test mode control signal.

2. The device according to claim 1, wherein a duration of the operation state is set to be shorter than a duration of the stand-by state in the intermittent operation.

3. The device according to claim 1, wherein
the circuit unit includes a sensor unit as the intermittent operation circuit and a control unit intermittently operating the sensor unit by receiving the operation control signal.

4. The device according to claim 3, wherein the sensor unit includes a sensor, an amplification circuit to receive an output of the sensor and a comparator to receive an output of the amplification circuit.

5. The device according to claim 4, wherein the control unit outputs a signal obtained from the comparator to outside, and receives an input including information to control operation of the sensor unit from outside.

6. The device according to claim 1, wherein both of the operation mode control unit and the operation timing generation unit constitute a sensor integrated circuit.

7. The device according to claim 1, wherein
the circuit unit includes a circuit being selected from a transmission unit, a reception unit and a transmission/reception unit, and is provided with a baseband signal unit and a radio frequency signal unit connected to the baseband signal unit constituting the intermittent operation circuit, and wherein
the baseband signal unit and the radio frequency signal unit operate intermittently by receiving the operation control signal.

8. The device according to claim 7, wherein the baseband signal unit receives a signal from outside, or outputs a signal to outside.

9. The device according to claim 1, wherein the baseband signal unit and the radio frequency signal unit constitute a transmission/reception module.

10. The device according to claim 7, wherein the predetermined time period operation performs the intermittent operation of the operation state and the stand-by state.

11. The device according to claim 10, wherein a duration of the operation state is set to be longer than a duration of the stand-by state in the predetermined time period operation.

12. The device according to claim 10, wherein a cycle time of the intermittent operation of the intermittent operation test mode is shorter than a cycle time of the intermittent operation of the intermittent operation mode.

13. The device according to claim 1, wherein the operation mode control unit and the operation timing generation unit are mounted on a single module board.

14. A device having a circuit capable of intermittent operation, comprising:
a signal processing circuit capable of selectively performing a normal operation and an intermittent operation performing alternately a normal state and a stand-by state;
an operation mode control unit generating a test mode control signal, the test mode control signal designating a normal operation test mode and an intermittent operation test mode of the signal processing circuit; and
an operation timing generation unit, receiving the test mode control signal, and outputting an operation control signal making the signal processing circuit perform the normal operation and the intermittent operation to the signal processing circuit based on the test mode control signal.

15. The device according to claim 14, wherein the intermittent operation test mode is set to be performed after the normal operation test mode.

16. The device according to claim 14, wherein the operation state and the stand-by state are alternately and periodically performed in the intermittent operation.

17. The device according to claim 14, wherein the normal operation performs an continuous operation.

18. The device according to claim 14, wherein the normal operation alternately performs an operation state and a stand-by state.

19. The device according to claim 18, wherein a duration of the operation state is set to be longer than a duration of the stand-by state in the normal operation.

20. The device according to claim 14, wherein a cycle time of the intermittent operation of the intermittent operation test mode is shorter than a cycle time of the intermittent operation of the intermittent operation mode.
